(19) United States
(12) Patent Application Publication
(10) Pub. No.: US 2003/0085391 A1
(43) Pub. Date: May 8, 2003

(54) Winch

(75) Inventor: Ingo Noske, Zweibrucken (DE)

Correspondence Address: COHEN, PONTANI, LIEBERMAN & PAVANE, 551 Fifth Avenue, Suite 1210, New York, NY, 10176, US

(73) Assignee: Demag Mobile Cranes GmbH & Co. KG

(21) Appl. No.: 10/290,715

(22) Filed: Nov. 8, 2002

(30) Foreign Application Priority Data
Nov. 8, 2001 (DE) 101 54 968.7

(51) Int. Cl. B66D 1/00

(52) U.S. Cl. 254/266; 242/579

(57) ABSTRACT

A winch includes a cylindrical cable drum with cable grooves machined into the surface. A lifting cable can be wound in a plurality of layers onto the grooves. Two flanged disks limit the cable drum laterally and have a securing device for the end of the lifting cable in the first layer of winding. The end of the lifting cable may be pushed into a cable duct which is machined within one of the two flanged disks and emerges from an emergence region of the cable duct substantially on the radius of curvature of the first layer of winding from the inner side of the one of the flanged disks. The course of the emergence region approximately corresponds to the helical course of the lifting cable in the first layer thereof. The lifting cable is retainable by non-positive or positive fitting in the cable duct.

### BACKGROUND OF THE INVENTION

1. Field of the Invention

The invention relates to a winch having a cylindrical cable drum with cable grooves machined into the surface on which a lifting cable is windable in a plurality of layers and two flanged disks limiting the cable drum laterally and having a securing device for securing the end of the lifting cable in the first layer of winding.

2. Description of the Related Art

Cable drums of cast or welded design are known, for example, from Dubbel, Taschenbuch für den Maschinenbau [Pocket Manual of Mechanical Engineering], 16th edn. (1987), T7, T8. The cable drums are usually motor driven via the winch. To dispose a winch equipped with such a cable drum with the maximum possible economy of space, the winch is pushed into the cable drum, which is configured as a hollow cylinder, and secured externally on an end face of the cylinder. In modern high-performance cranes, winches are used with cable drums which store cable lengths of 1000-1500 m. The driving torque of the winch drive must be designed for a fully would cable drum to guarantee the maximum lifting power. In other words, the driving torque must be designed for the maximum winding diameter of the lifting cable. Therefore, to minimize the required size of the drive motor, the diameter of the cable drum should also be as small as possible. For a compact construction, efforts are made to achieve not only a small diameter of the cable drum but also the shortest possible axial length of the cable drum.

To correctly wind the lifting cable onto the cable drum, one of the two ends of the lifting cable must be reliably fixed to the cable drum. This may be achieved using an aperture in the cylindrical shell of the cable drum. The cable end is reshaped to form an eye and is pushed into the aperture by a retaining wedge. However, this design is frequently unsuitable because it obstructs the insertion of a transmission gear in the cable drum. As an alternative, however, it is known to secure one of the two cable ends in the region of one of the two flanged walls of the cable drum. For this purpose, the respective flanged wall is provided with a corresponding through hole, through which the cable end is guided from the inside of the flanged wall to the outside. The cable end is then secured externally by a retaining device. However, the retaining device uses a corresponding amount of structural space and consequently increases the overall axial length of the cable drum.

Furthermore, the known cable end securing systems subject the cable ends to bends with a very small radius of curvature which may result in severe stresses and damage during operation.

### SUMMARY OF THE INVENTION

It is an object of the present invention provide a winch having a cable drum that takes up as little structural space as possible with the shortest possible axial structural length and does not prevent the insertion of the transmission gear through the drum body.

The object of the present invention is achieved by a winch for winding a lifting cable including a cylindrical cable drum having a cylindrical outer surface with cable grooves having a helical course machined into the cylindrical outer surface and flanged disks laterally limiting the cable drum. The cable grooves are adapted to receive a first layer of the lifting cable thereon. The winch further includes a securing device adapted to secure an end of the lifting cable. One of the flanged disks defines a cable duct adapted to receive the end of the lifting cable. The one of the flanged disks has an inner side facing said cable drum and an outer side facing away from said cable drum. The cable duct has an emergence region which opens to the inner side of the one of the flanged disks in an area for receiving the first layer of the lifting cable on the cable drum and has a course approximately corresponding to the helical course of the cable grooves. The cable duct is further adapted to retain the lifting cable therein by one of a positive and non-positive fitting

It is an object of the present invention to provide a cable end securing system which does not have disruptive structural projections either on the outside of the flanged disks of the cable drum or on the inside of the hollow cylindrical cable drum. This object is achieved in that the end of the lifting cable is pushed into the cable duct which is machined within one of the two flanged disks and substantially emerges from the emergence region of the cable duct on the radius of curvature of the first layer of lifting cable from the inside of the one of the flanged disks and possesses, at least in the emergence region, a course approximately corresponding to the helical course of the lifting cable in the first layer thereof receivable on the cable drum. The emergence region of the cable duct follows a course only slightly different from the helical course of the cable winding. The emergence region expediently extends over a circumferential angle of at least 5°, preferably at least 10°, especially at least 15°. In the practice, the emergence region may be bent slightly more toward the outer side of the flanged disk than the regular pitch of the cable windings. Thus, the lifting cable extending through the emergence region is subjected only to very slight curvature. What is essential is that the central line of the emergence region lies substantially on the radius of the first layer of winding of the lifting cable. That is, the central line of the emergence region lies on the radius of curvature of the first layer of the lifting cable receivable on the cable drum. The emergence region of the cable duct is thus to this extent curved in the same way as the lifting cable in the further course of its winding. According to the present invention, the lifting cable inserted into the cable duct is optionally retained by non-positive or positive fitting.

The cable duct makes a transition from the emergence region into a section substantially parallel to the inner side of the associated flanged disk. The cable duct thus retains, in this parallel section, a constant distance from the inner side, and does not lead to the outer side of the flanged disk. Thus, the outer side of the flanged disk is kept free of any structural projections of the cable end securing system. The parallel section of the cable duct extends in an arcuate manner with the same curvature as the first cable winding. As a result, the cable duct, in the region of the transition zone, can be retained between the cylindrical part of the cable drum and the flanged disk, and thus be retained in a zone with a relatively large accumulation of material.

The lifting cable may be retained in the cable duct by non-positive fitting. For this purpose, the present invention provides that the end of the lifting cable in the cable duct is pressed by a cable wedge against all inner wall of the cable duct so that the lifting cable is wedged against the cable duct. A profiled member curved in the form of all annular section may be used as the cable wedge, the profile thereof being adapted first to the cross-sectional shape of the cable duct and secondly, preferably, to the toroidal surface of the lifting cable provided with the winding curvature. Furthermore, the cable wedge and the cable duct may comprise mutually corresponding sliding surfaces which, viewed in cross section, extend at an acute angle to the longitudinal axis of threaded through bores which are made from the outside of the flanged wall and end in the cable duct. Clamping screws may be driven into these threaded through bores, these acting upon the clamping wedge and pressing the latter against the lifting cable in accordance with the inclination of the sliding surfaces, achieving the above-described wedge effect. If the cable wedge material is less hard than the lifting cable, the surface of the lifting cable is pressed into the cable wedge and imparts a profile to the latter, thereby producing a degree of positive fitting between the cable wedge and the cable surface in addition to the initial non-positive fitting.

It is recommended that at least a portion of the cross-sectional shape of the cable duct be configured over a part of its contour as a circle corresponding to the diameter of the lifting cable. This configuration allows the lifting cable to contact the inner surface of the cable duct over a large area.

To ensure that the cable end securing system still provides secure retention for the lifting cable even in the event that the tensile force applied to the unwinding lifting cable exceeds the nominal load by a multiple, the cable duct tapers conically in the emergence region toward the inner side of the flanged disk. The tapering is configured so that, in the event of slippage, the cable wedge is automatically jammed in this tapered part of the cable wedge to prevent a further running-out of the lifting cable.

The end of the cable duct opposite to the emergence region is bent onto the inside of the flanged disk toward a second aperture. The pushed-in end of the lifting cable and the inserted cable wedge are accessible through this second aperture from the inside of the flanged disk. This has particular advantages with thicker cables that have a diameter, for example, of at least 30 mm. In this case, the lifting cable may be drawn through the second aperture by an auxiliary cable that is attached thereto. After the lifting cable has been drawn through the second aperture, the auxiliary cable may be removed from the lifting cable.

The solution according to the present invention for a cable end securing system for a winch not only permits a comparatively short axial structural length of the cable drum without any structural projections caused by the cable end securing system, but additionally guarantees an exceptionally protective securing system because sharp bending of the cable is avoided.

Other objects and features of the present invention will become apparent from the following detailed description considered in conjunction with the accompanying drawings. It is to be understood, however that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is an axial longitudinal sectional view of a winch according to the present invention;

FIG. 2 is a partial sectional view of a flanged disk of the winch in FIG. 1 with a cable duct;

FIG. 3 is a longitudinal sectional view of the cable duct of FIG. 2;

FIGS. 4a-4h are cross sectional views of th cable duct shown in FIG. 3;

FIGS. 5a-5c are sectional views of the cable duct in various planes of section;

FIGS. 6a and 6b are partial sectional views of the flanged disk with cable duct and inserted cable wedge; and

FIG. 6c is a side view of the cable wedge.

### DETAILED DESCRIPTION OF THE PRESENTLY PREFERRED EMBODIMENTS

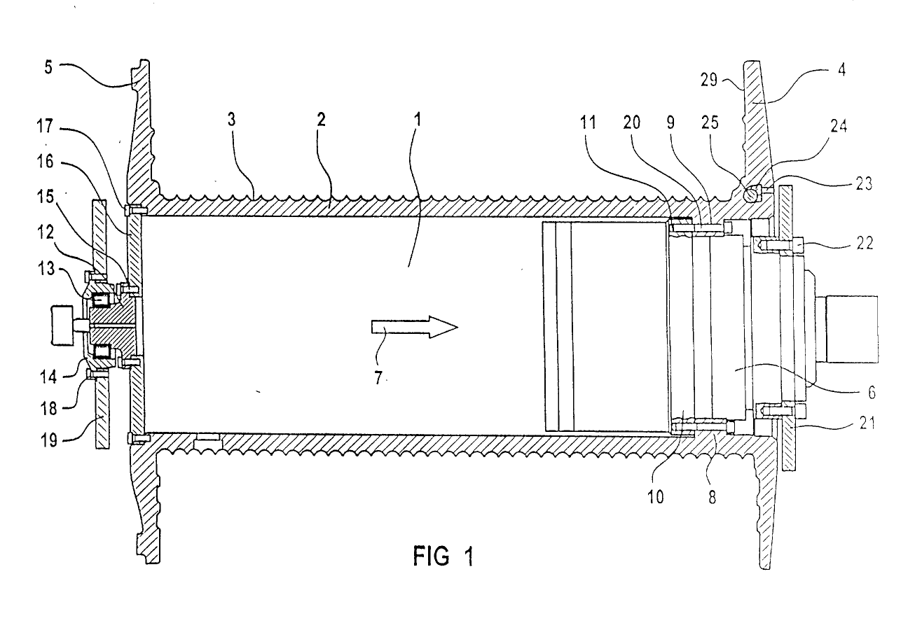

A winch 1 according to the present invention is shown in FIG. 1 including a cast cable drum 2 configured as a hollow cylinder with cable grooves 3 disposed on the outer shell surface thereof in a helical manner. In compliance with the accident prevention regulations, flanged disks 4, 5 are respectively arranged at the end regions of the cable drum 2. The height of the flanged disks 4, 5 is dependent upon the thickness of the cable winding provided. According to the present invention, not only the right-hand but also the left-hand end face (movable bearing face) of the hollow cable drum 2 is open. A planetary gear assembly 6, indicated only diagrammatically in FIG. 1, may be pushed in from the left-hand side, as shown by the arrow 7. To connect the gear assembly 6 to the cable drum 2, the inside of the cable drum 2 comprises an annular, inward extending shoulder 8 with through bores 9 disposed over the circumference. A contact region 10 which comprises a portion of the gear assembly 6 which impacts upon the shoulder 8 and includes threaded bores 11 which match the through bores 9. Fixing screws 20 are pushed through the through bores 9 and screwed into the threaded bores 11 in the steel body of the contact region 10. Accordingly, screws do not have to be driven into the cast body of the cable drum 2. The portion of the gear assembly 6 which forms the fixed bearing face of the cable drum 2 is secured via screws 22 to a support member 21.

A movable bearing on the left hand side of the cable drum 2 in the embodiment shown in FIG. 1 includes an inner bearing body 12, a roller bearing 13 and an outer bearing body 14 configured as a cover. The inner bearing body 12 is secured by screws 15 to a cover flange 16, which is connected via screws 17 to the cast body of the cable drum 2 to close the end face region of the cable drum 2. The thread in the cable drum 2 for the screws 17 is non-critical for strength purposes, because the driving torque of the cable drum 2 does not have to be transmitted via these screws. The outer bearing body 14 is connected by screws 18 to a support element 19, which is only schematically indicated here.

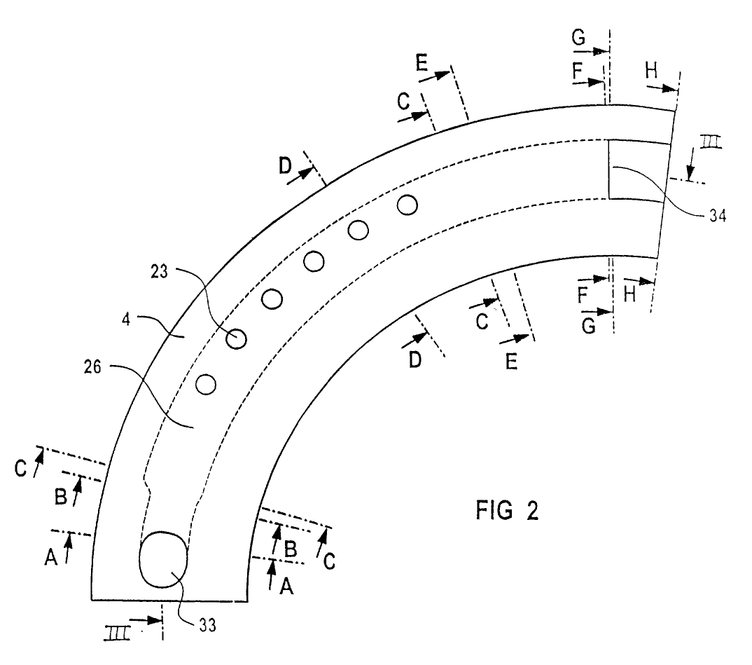

The planetary gear assembly 6 which is inserted from the left-hand side and internally secured on the right-hand side of the cable drum 2 guarantees a very short axial structural length. Furthermore, the insertion of the planetary gear assembly 6 is in no way obstructed by the cable end securing system of the lifting cable 25. The cable end securing system includes a cable wedge 24 which is worked, together with the lifting cable 25, into a cable duct 26 in the flanged disk 4. Details of the cable end securing system are shown in the further FIGS. 2 to 6c.

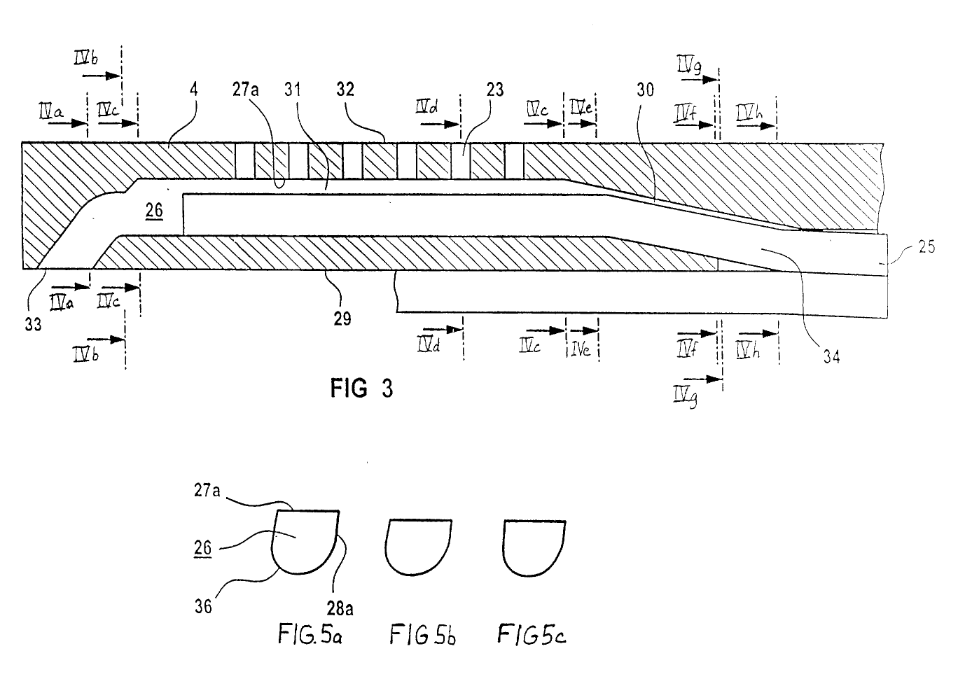

FIG. 2 is a sectional view from the inside of the flanged disk 4, viewed in the direction of the longitudinal axis of the cable drum 2. The arcuate course of the cable duct 26 is shown in broken lines and corresponds to the radius of curvature of the first layer of the lifting cable (not shown in FIG. 2) receivable on the cable drum 2. The lifting cable 25 may be introduced through the aperture 34 into the cable duct 26. A further aperture 33 is disposed at the end of the cable duct 26 opposite the aperture 34 which, like the aperture 34, is open to the inner side 29 of the flanged disk 4. This configuration is apparent from FIG. 3, which is a sectional view through the flanged disk 4 along the central line of the cable duct 26. From an outer side 32 of the flanged disk 4, opposite to the inner side 29 of the flanged disk 4, a total of six threaded through bores 23 are guided into the cable duct 26. Screws or threaded pins (not shown) can be driven into these threaded through bores 23 from outer side 32.

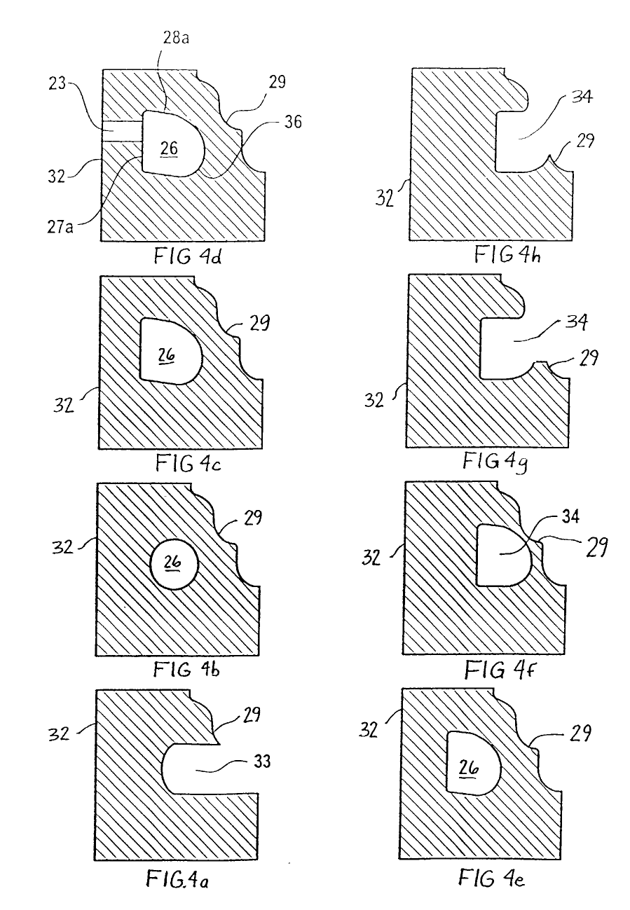

To provide a clearer understanding of the cross-sectional configuration of the cable duct 26, various sections IVa-IVa to IVh-IVh are depicted in FIG. 3 and are shown diagrammatically in FIGS. 4a-4h, respectively. The direct environment around the cable duct 26 between the inner side 29 and the outer side 32 is shown in each section. The upper and lower parts of the flanged disk 4 are omitted in each case. The section IVa-IVa lies proximate the aperture 33. The cable duct 26 has, as far as the section IVb-IVb, a circular cross section corresponding to the diameter of the lifting cable 25. Therefore, it is possible to verify through the aperture 33 whether the lifting cable 25 has been pushed sufficiently far into the cable duct 26. From the section IVb-IVb to the section IVc-IVc, the cable duct 26 opens, over a short part of its axial length, from the circular shape to a different cross-sectional shape, which now only has one arcuate piece of approximately a quarter-circle and is otherwise substantially made up of straight sections with radii of curvature in the transition region.

The section IVd-IVd corresponds in the cross section of the cable duct 26 to that of section IVc-IVc. The only additional item identifiable in FIG. 4d relative to FIG. 4c is the section through one of the threaded through bores 23. In a parallel section 31 of the cable duct 26, which extends parallel to the inner side 29 and outer side 32 of the flanged disk 4, the cable duct 26 has, apart from the circular part 36 of its contour, a contact surface 27a parallel to the outside 32 and a sliding surface 28a which is inclined at an acute angle to the longitudinal axis of the threaded through bore 23. According to FIG. 3, the parallel section 31 is adjoined on the right by an emergence region 30 of the cable duct 26, bent slightly toward the inside 29. The emergence region 30 extends approximately from section IVe-IVe to the section IVg-IVg. The emergence region 30 extends with an open side to section IVh-IVh. In this emergence region 30, the cross section of the cable duct 26 tapers conically. This becomes apparent, in particular, from the comparative illustration of the duct cross sections in FIGS. 5a-5c. FIG. 5a, which corresponds to the contour at sections IVc-IVc and IVd-IVd, shows the constant cross-sectional shape in the region of the parallel section 31. In FIG. 5b, which corresponds to section IVe-IVe, the size of the contact surface 27a is unchanged by comparison with the first section but the size of the sliding surface 28a is decreased. FIG. 5c, which corresponds to section IVf-IVf, the sliding surface 28a now remains constant but a change has taken place in the angle between the contact surface 27a and the connecting surface between the contact surface 27a and the circular part 36 of the contour. The originally slightly obtuse angle has become a right angle.

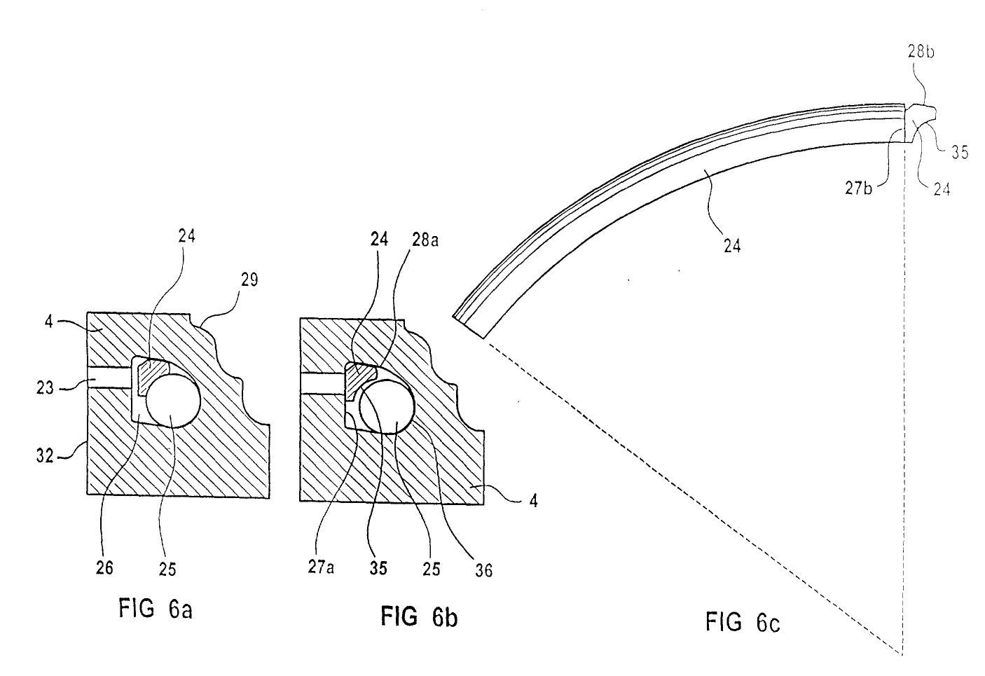

The manner in which the cable end securing system according to the present invention operates is particularly apparent from FIGS. 6a-6c. The arcuate course of the cable wedge 24 is shown in FIG. 6c along with the profiled shape thereof in cross section. FIGS. 6a and 6b show the functional principle of wedging the cable in two different phases. FIGS. 6a and 6b correspond to section IVd-IVd in FIG. 3. FIG. 6b shows that operative state in which the pushed-in lifting cable 25 contacts the circular contour 36 of the cable duct 26. The arcuate contact surface 35 of the cable wedge 24 is still at some distance from the surface of the lifting cable 25. In the extreme top left-hand corner, cable wedge 24 is in contact both by a contact surface 27b with the contact surface 27a of the cable duct 26 and by its sliding surface 28b with the sliding surface 28a of the cable duct 26. If a sufficiently long screw 42 (see FIG. 6a) is now driven into the threaded through bore 23, the screw 42 presses on the contact surface 27b of the cable wedge 24 and pushes the latter along the sliding surface 28a toward the lifting cable 25 until the arcuate contact surface 35 abuts the lifting cable 25. The inclination of the sliding surface 28a relative to the longitudinal axis of the threaded through bore 23 and the contact pressure of the screw 42 create a wedge effect which produces substantial contact pressure forces between the lifting cable 25 and the cable wedge 24. With appropriately matched pairing of materials, i.e., when the cable wedge 24 is a softer material than the lifting cable 25, the surface of the lifting cable 25 is pressed into the cable wedge 24 and imparts a profile to the latter, thereby effecting a positive fitting for a particularly secure retention of the lifting cable 25 on the cable wedge 24.

The cable end securing system on the cable drum achieved by the construction according to the present invention allows the winch frame, which is intended to retain the cable drum, to be narrowly configured and thus economical of space and weight. This is attributable to the fact that the selected cable end securing system entails no structural projections over the flanged disks of the cable drum.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A winch for winding a lifting cable, comprising:
a cylindrical cable drum having a cylindrical outer surface with cable grooves having a helical course machined into said cylindrical outer surface and flanged disks laterally limiting said cable drum, said cable grooves adapted to receive a first layer of the lifting cable thereon;
a securing device adapted to secure an end of the lifting cable, wherein one of said flanged disks defines a cable duct adapted to receive the end of the lifting cable, said one of said flanged disks having an inner side facing said cable drum and an outer side facing away from said cable drum, said cable duct having an emergence region which opens to said inner side of said one of said flanged disks in an area for receiving the first layer of the lifting cable on said cable drum, said emergence region having a course approximately corresponding to said helical course of said cable grooves, said cable duct adapted to retain the lifting cable therein by one of a positive fitting and a non-positive fitting.

2. The winch of claim 1, wherein said emergence region of said cable duct extends over a circumferential angle of at least 5°.

3. The winch of claim 1, wherein said emergence region of said cable duct extends over a circumferential angle of at least 10°.

4. The winch of claim 1, wherein said emergence region of said cable duct extends over a circumferential angle of at least 15°.

5. The winch of claim 1, wherein said cable duct comprises a further section parallel to said inner side of said flange joining said emergence region.

6. The winch of claim 5, wherein said parallel section extends in the circumferential direction substantially on the radius of curvature of the first layer of the lifting cable receiveable on said cable drum.

7. The winch of claim 1, wherein said cable duct tapers conically in said emergence region toward said inner side of said one of said flanged disks.

8. The winch of claim 1, further comprising a cable wedge arranged in said cable duct for wedging the lifting cable within the cable duct against an inner wall of the cable duct.

9. The winch as claimed in claim 8, wherein said one of said flanged disks defines threaded through bores extending from the outer side thereof to said cable duct for receiving clamping screws driveable to set a clamping force of said cable wedge.

10. The winch as claimed in one of claims 9, wherein said cable wedge and said cable duct comprise mutually corresponding sliding surfaces which extend at an acute angle to the longitudinal axis of the threaded through bores.

11. The winch of claim 8, wherein said cable wedge is a profiled member curved in the form of an annular section.

12. The winch of claim 8, wherein said cable wedge comprises a bearing surface adapted to a toroidal shape of the lifting cable.

13. The winch of claim 10, wherein said cable wedge comprises a bearing surface adapted to a toroidal shape of the lifting cable.

14. The winch of claim 8, further comprising a lifting cable pulled through said cable duct, wherein said cable duct is formed from a material that is less hard than a material of said lifting cable.

15. The winch of claim 1, wherein said cable duct is configured over a part of its contour as a circle having a radius corresponding to half a diameter of the lifting cable receivable thereon.

16. The winch of claim 1, wherein said one of said flanged disks defines a second aperture of said cable duct at an end of said cable duct opposite said emergence region, said cable duct being bent toward said second aperture at said end opposite said emergence region.
